(19) United States
(12) Patent Application Publication
(10) Pub. No.: US 2020/0254937 A1
(43) Pub. Date: Aug. 13, 2020

(54) Inflatable Vehicle Seat Container

(71) Applicant: Daniel V. Ginzburg, Van Nuys, CA (US)

(72) Inventor: Daniel V. Ginzburg, Van Nuys, CA (US)

(21) Appl. No.: 16/274,056

(22) Filed: Feb. 12, 2019

(51) Int. Cl. B60R 7/04; B65D 25/04

(52) U.S. Cl. CPC B60R 7/043; B65D 25/04

(57) ABSTRACT

This is an organizing accessory for vehicle interiors placed on the top of the front or back passenger seats. It can be inflated and deflated with a press of a button. It is inflated and deflated using a built-in motor. The motor connects to a 12V car charger slot, making it universal for any vehicle. The container is comprised of air proof material that allows it to be inflated and to hold air. The organizer is equipped with several pockets, a divider in the middle and a slot in one of the walls for large thin items such as an iPad, tablet or a folder. The inflatable cuboid attached to the bottom of the container serves as a stabilizing base that ensures the stability of the container. The cuboid and the container share airspace so they inflate and deflate simultaneously.

### CROSS-REFERENCE TO RELATED APPLICATIONS

Not applicable

### STATEMENT REGARDING FEDERAT LY SPONSORED RESEARCH OR DEVELOPMENT (IF APPLICABLE)

Not applicable

### REFERENCE TO SEQUENCE LISTING, A TABLE, OR A COMPUTER PROGRAM LISTING COMPACT DISC APPENDIX (IF APPLICABLE)

Not applicable

### BACKGROUND OF THE INVENTION

The field of endeavor that the invention pertains to is automotive interior accessories. What inspired this invention are extremely disorganized car interiors. Many people who keep a lot of items in the car have a hard time finding them or reaching them. There was an attempt to solve this problem with plastic or rubbery containers, baskets and organizers. However they were very space consuming. To free up the space they took up, they had to be emptied out and then dragged out. This created two additional problems, where to put them and all the stuff that was in them.

Moreover, those kinds of baskets and container usually could never be anywhere easy to reach. They could not be on the back or front passenger seats because they would slide off when the car would break or slide to the side when the car would turn. So they were placed on the floor on the back, which made it hard to reach for items that were in it and definitely hazardous to even attempt to reach while driving. They were placed on the floor of the front passenger seat, but then no passengers could ride in the front seat because the container would obstruct their leg space. In the trunk, they were inaccessible without getting out of the car and opening the trunk, which defeated all of the convenience.

In addition none could be used to insert a large slim item such as a table or a folder. Such an item could be placed inside the volumetric capacity but then it would not be in a vertical position, which made it hard to retrieve. Some had big pockets but that did not ensure the stability of items put in them. Some pockets were made specifically for an iPad, but then could not be used for other items that were bigger or thicker.

### BRIEF SUMMARY OF THE INVENTION

The inflatable vehicle seat container is the solution to all of those problems. It is used for organizing and storing personal belongings that normally end up in people's cars. The invention was designed to decrease the number of items scattered all over the car interiors and reduce the difficulty of finding needed items. It also solves the problem of reaching any item with ease. It can be placed on the back and front passenger seats so it is high enough to be easily accessed from the driver's seat, even while driving. Yet the best part is that it will not slide to the side when the car turns or slide off the seat upon stopping.

In case if the person needs the additional space in the car, they do not have to go through the struggle of dragging the container out of the car and having no place to put it. They can just quickly deflate it with a press of a button. The container has a built-in motor inside that inflates it and deflates it through a 12V car charger slot. Once deflated it can be rolled up and easily stored somewhere in the car, purse or just removed altogether.

The container comes with a stretchable safety cover. If there are items in it, the safety cover can be strapped on and secured by the plastic hooks on each corner. This will safeguard all the items inside the container. So once deflated it can continue to serve as a container for all of the items in it. One no longer would have to look for a place to move everything that was in it to take the container out.

The stretchable safety cover has another function. If strapped on, it would prevent the items in it from flying out in the direction of the driver or the front windshield if the car comes to a sudden stop or gets in an accident.

The container is a true organizer. It has two large pockets on the outside, 4 pockets on the inside and a slot for an iPad, tablet or a folder in addition to a removable divider, which can split the space inside the container into compartments. One can put their purse, water bottle, watch, glasses, bag, keys, wallet, clothes all at once and not have to struggle turning the entire car upside down to find what they need. Yet most of all, the car's interior would look nice, clean and presentable.

the divider is removed, one can even put a small dog or other pets in the container to make sure the pet does not bounce around the car on turns or sudden stops. The inflatable soft walls keep the pet safe. This also keeps the interior clean because if the pet is dirty he/she will not stain the seats or the floor.

The slot for the iPad, tablet or a folder allows the item to be tightly inserted. Since it is only 150 mm deep it enables the item to be easily retrievable. Because the container is inflatable the item sits in the slot very firmly and does not move around. Also because it is inflatable, something that is paper-thin or 2 inches thick can be inserted in it and would not wobble around.

### BRIEF DESCRIPTION OF THE SEVERAL VIEWS OF THE DRAWING

FIG. 1—depicts the container in perspective view with all the dimensions. It also shows the safety cover and the 12V power plug coming out of it that is used to inflate and deflate the container.

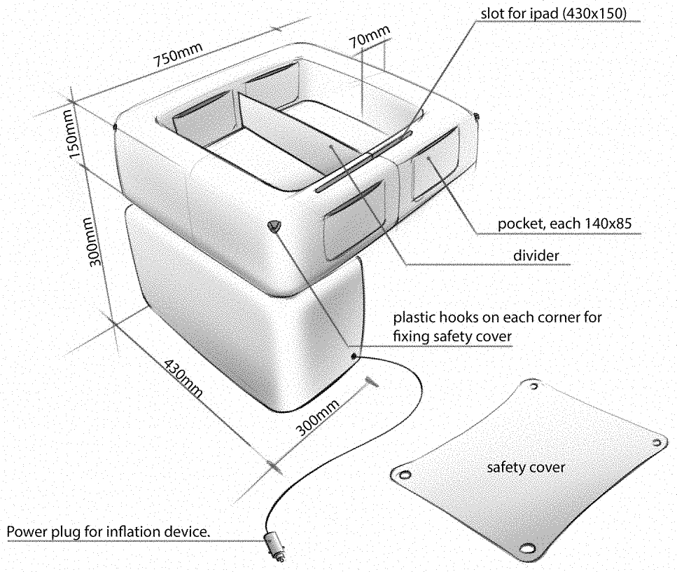

### DETAILED DESCRIPTION OF THE INVENTION

The organizer is used by placing it on the back seat or the front passenger seat. It is meant to be placed on the seat with the inflatable cuboid base hanging down in a deflated form and then inflated so that it takes form of the seat's 90 degree shape. The 12V power plug gets inserted into the car charger slot. The adapter would have two buttons on it. One button would say “inflate” which would inflate the container upon pressing it and the second button would say “deflate” which would deflate it upon pressing it. The wire would go from the adapter to the motor that would inflate and deflate the container.

The motor can be any motor that is used for inflating. The smaller it is the easier it is to fold the organizer when deflated. The motor has to be a 12V so that it would be compatible with all car adapters. The motor's fan has to be able to spin in both directions so that it could inflate and deflate the container.

The large inflatable cuboid base touches the floor and serves as the support for the top portion so that one can put heavy items at the very front of the container without it tipping over. The cuboid also serves as a stabilizer that prevents the organizer from sliding from side to side when the car turns or to the front when the car stops. The cuboid and the top portion are glued and stitched together. There is a hole between them inside, so they share airspace, which allows both to be inflated simultaneously.

The container is built by stitching and gluing together any airproof material that is used for any inflatable item such as inflatable headrests, inflatable mattresses or inflatable pillows. The shape of the pieces attached to each other can differ. The outside fabric could be any fabric since there are many pockets and compartments that would prevent the items from sliding even if the fabric doesn't have grip such as suede.

The divider in the middle would be made out thin plastic wrapped in fabric that the rest of the container is made out of. The divider would be removable. It would be inserted into slots on both sides of the sidewall between the two inside pockets on each side. The two pockets are stitched to the inside of the two sidewalk. Similarly there are two pockets are stitched to the outside of the sidewall that is closest to the driver, (assuming that the container is on the right side of the vehicle and the driver is on the left side). The pockets are stitched to the fabric and not to the airproof material.

The bottom of the container would not be inflatable. it would be double stitched to the bottom of the four walls of the container. The bottom would be made out of the same airproof material as the rest of the container for durability. It would be covered from both sides with the same fabric as the rest of the container.

The safety cover is made out of any polyester stretchable material as long as it is durable. It must be able to not rip when stretched by 30 lb. The four holes in it where the plastic hooks will go will have to have metal ring coverings so that the holes would not stretch out and rip overtime when the cover is used.

The container is different form all other similar items because it is inflatable. It is also unique because of the slot for an iPad, tablet or a folder. Since the container is inflatable, the slot is a very tight space that offers maximum stability for whatever is inserted in it. The container's ability to be deflated allows it to be easily removed, which is what mainly distinguishes it from all other analogous accessories.

1. An inflatable vehicle seat container, comprising:
an inflatable, rectangular open top container with a non-inflatable, flat, thin bottom and an empty space inside enabling said container to be used for storage;
and an inflatable cuboid;
wherein said cuboid's one of two smallest flat surfaces is attached to a bottom of said container;
wherein said cuboid's width is aligned with said container's width;
wherein said cuboid and said container will share air space enabling both to be inflated simultaneously.

2. The invention of claim 1 wherein any one of the four walls of said container is equipped with a slot in a middle enabling said slot to be used for storage of slim items;
wherein said slot is positioned in length of said wall of said container;
wherein said slot can be any length as long as said slot fits within said wall;
wherein said slot fits from a top into said wall.
